(19) United States
(12) Patent Application Publication
(10) Pub. No.: US 2005/0007886 A1
(43) Pub. Date: Jan. 13, 2005

(54) Analog timepiece with a plurality of digital display functions

(76) Inventor: Michael J. Mazzetti, Santa Barbara, CA (US)

Correspondence Address: MICHAEL J. MAZZETTI, 1168 PALOMINO ROAD, SANTA BARBARA, CA, 93105, US

(21) Appl. No.: 10/613,309

(22) Filed: Jul. 7, 2003

(51) Int. Cl. G04B 19/04; G04B 19/24

(52) U.S. Cl. 368/80

(57) ABSTRACT

An analog timepiece with novel means for the digital display of day of the week and month along with month of the year or other pertinent information. Several or all of the ordinal hour demarcations 1 through 12 being represented by alphanumeric digital display elements. Positioning of these display elements serve a primary role as locators for the analog hour hand and minute hand while simultaneously presenting characters of alpha-numeric data.

### FIELD OF INVENTION

The present invention generally relates to a timepiece that communicates additional data, and more specifically, to an analog timepiece that can communicate calendar data and other information.

### BACKGROUND—PRIOR ART

Analog timepieces providing calendar information are well know in the art. Typically, prior art describes an analog timepiece comprising a housing, a transparent protective cover (i.e. crystal), at least one mechanical “hand”, a faceplate, and a mechanical and/or electronic timekeeping assembly. Typically, the faceplate is marked with ordinal numbers or graphic symbols, over which at least one mechanical “hand” rotates to communicate time of day information. Additionally, calendar information may be communicated utilizing a separate mechanical “hand” or “dial”, which typically are very small, and thus difficult for the user to read. A separate window, communicating date information, is often positioned at the “3-'clock” or “6-o'clock” positions, and may necessitate a magnifying-glass section and/or sections on the crystal to improve user readability. This date information often requires resetting by the user for months of less than 31 days. Such timepieces tend to present a cluttered appearance, and the small characters utilized to communicate the calendar information are periodically obscured by the mechanical hand and/or hands.

In comparison, digital timepieces, may include large and clear displays for day of the week and month of the year, in written form or abbreviations; that is, “Mon” to represent Monday, “Dec” to represent December, and so on. Additional features and functions may include alternate time zones, alarms, stopwatches, and user programmed information such as phone numbers, addresses, and the like. Moreover, digital timepieces may include perpetual calendars, which automatically determine and communicate the proper day of the week, number of days in a month, and the like; either for the past, present, or future years. Such digital timepieces however, wristwatches in particular, are less appealing to many users, because digital timepieces do not communicate time information in a “graphic” and “instantly perceived” manner as provided by an analog timepiece.

Timepieces combining both analog time representation and digital calendar information, typically include small and difficult to read digital displays, which are periodically obscured by the mechanical hand or hands. Other approaches position digital displays at separate areas of the timepiece faceplate, so as to not be obscured by the analog mechanical hand or hands. This approach necessitates reducing the size of both the digital and the analog portions of the timepiece faceplate.

### SUMMARY OF INVENTION

The present invention improves the typical analog timepiece, by replacing the common twelve ordinal numbers with alternate graphic symbols. The user need only recognize a reference point to orient analog hand or hands (with the sequence of 1 to 12 having been committed to memory). Thus, these symbols and areas of a timepiece faceplate may be put to additional use as elements of a digital display, in the vast majority of timekeeping devices, such as wristwatches, pocket watches, wall clocks, automotive dashboard clocks, and the like. Each of the twelve areas can now display numbers 1 through 31, letters of the alphabet, Roman numerals, or any other alternate symbol. The display may be large and un-obscured by an analog mechanical hand or hands. Information is controlled by internal electronics as is typical of digital timepieces. The twelve display areas may comprise a single device, such as a liquid crystal display with dot matrix patterns at each area, or similar technology.

The present invention can communicate a vast amount of information for unexpected applications previously unavailable in current timekeeping devices. Any information that can be condensed to twelve or less characters, or groups, or symbols can be communicated, while maintaining the overall appearance and readability of an analog timepiece. The placement and meaning of traditional hour numbering can be altered to communicate a vast amount of divergent information. Additional effects are easily incorporated for artistic and styling purposes. A single timepiece may now present many different functions and appearances as selected by the user.

### DRAWING FIGURES

FIG. 1 is a face view of analog hands and display areas.

FIG. 2 is a cross sectional view of FIG. 1 showing the timepiece elements.

FIG. 3 shows day, date, month, and year as one use of the display in a rectangular body.

FIG. 4 shows a 24-hour mode of display in a circular body.

FIG. 5 shows symbols as hour locators with changing properties to convey graphic information.

FIG. 6 shows rotated hour locations to convey alternate time zones (2:00 local, 5:00 alternate).

### REFERENCE NUMERALS IN DRAWINGS

8 TIMEPIECE
10 ANALOG HANDS
12 DIGITAL DISPLAY
14 DISPLAY AREA
16 HOUR MARKS
18 BODY
20 SHAFT
22 CONNECTOR
24 CONTROL CIRCUITS
26 BUTTON
28 WINDOW
30 DAY
32 DATE
34 SUFFIX
36 MONTH
38 YEAR
40 TOP LOCATION
42 CIRCULAR BODY
50 DARKENED SYMBOL
52 TRANSITION LINE
54 LIGHTENED SYMBOL
60 DISTINCTIVE TOP LOCATION
62 ALTERNATE TIME

### DETAILED DESCRIPTIONS OF PREFERRED EMBODIMENTS

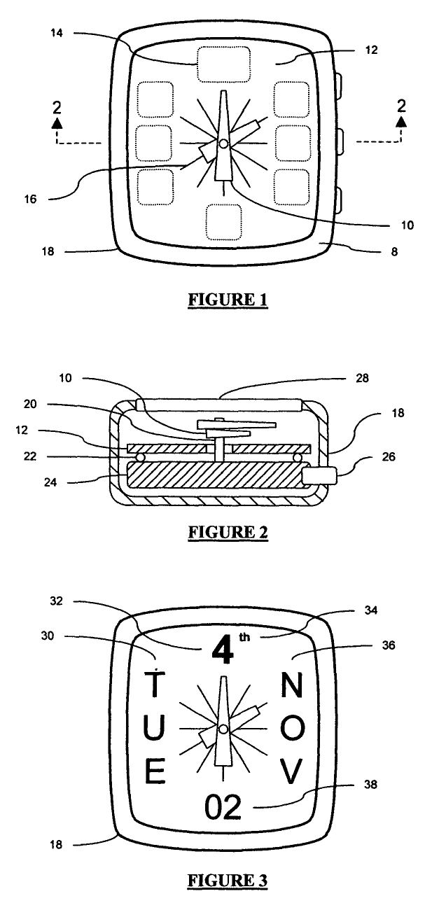

FIG. 1 depicts a first embodiment of the present invention. Timepiece 8 includes analog hour and minute hands 10 indicating the current time of day. A digital display 12 includes display areas 14 located at demarcation points for the hours. Each display element includes an array or segment for the creation of text, numbers, or symbols. Additional hour markings 16 may be added for visual clarity of the hour positions.

FIG. 2, depicts a cross-sectional view of the timepiece 8, at line 2. In FIG. 2, the analog hands 10 reside atop mechanical shafts 20 that pass through the digital display 12. A connector 22 beneath this display makes electrical contact to control circuits 24 which reside within the timepiece body 18. Buttons 26 provide user control for the settings of the control circuits 24. A transparent window 28 forms the top of the body and allows for viewing of the display face.

FIG. 3 depicts one embodiment of the digital display 12 for the indication of current day of the week 30, day of the month 32, a date suffix 34, month of the year 36, and year 38. In this embodiment the 1:00, 5:00, 7:00 and 11:00 o'clock positions are left blank. Special display elements next to the top center area provide the appropriate suffice 34 to make numbers more readable (i.e. 1^{st}, 2^{nd}, 3^{rd}, 4^{th}, etc.)

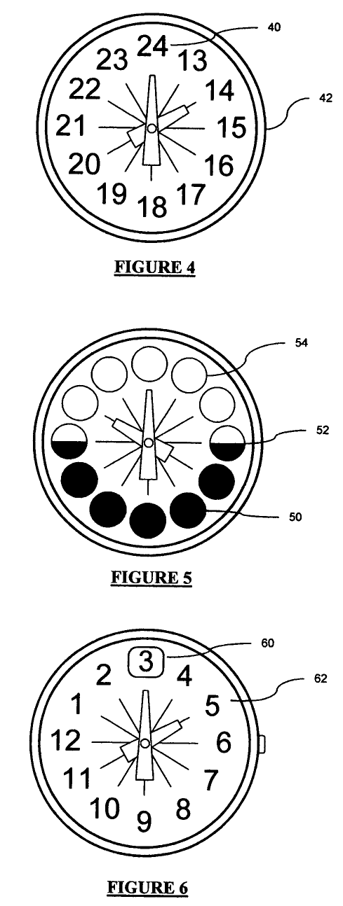

FIG. 4 depicts another embodiment of the present invention, which includes a twenty-four hour mode, and a circular embodiment of the timepiece body 42. In this embodiment, digital display areas display numbers thirteen through twenty-four during the PM period of the day with the top location 40 displaying the number twenty-four. Digital display areas display the numbers one through twelve during the AM period of the day with the top location 40 displaying the number twelve.

FIG. 5 depicts a further embodiment which uses symbols for the hour demarcations. Symbols (or text or numbers) may be altered in appearance for visual effect. Effects may include removing the symbol entirely or reversing elements such as black and white. A darkened symbol 50 is shown at the bottom location. A symbol changed half way to indicate the location of a transition line 52 is shown at the 3:00 and 9:00 positions. This may represent current tide levels or any trend or value to be presented in a graphic visual manner. The top location depicts a lightened symbol 54 by contrast. Information such as the current phase of the moon can utilize a similar technique with the transition moving from left to right rather than bottom to top.

FIG. 6 depicts a further embodiment of the present invention, that being a dual time zone mode of operation. The digital display elements indicate hours one through twelve in rotated positions. In this embodiment, the local time is determined by reading the traditional hour and minute hand positions, as indicated by the analog hands (2:00). The top location 60 may be made distinctive to enhance normal orientation, such as reverse indication, italics, or bold text. This top location is shown to display the number three which represents the difference in hours, set by the user, between time zones. The alternate time 62, of 5:00 in this embodiment, is determined by reading the number in proximity to the hour hand.

All of the functions, or a subset thereof, of the previous embodiments may be provided by a single multipurpose embodiment under the control of electronic circuits. The user can select which form of display and which information to be displayed by the use of controls and settings. The user may also select an appropriate language to be used for textual information.

An alternate construction may utilize selectively transparent digital display elements placed above the mechanical analog face and hands. This precludes the need for a hole in the digital display 12 to accommodate the mechanical shaft 20.

Alternate embodiments may utilize a single electronic display for both the digital elements and graphic representations of analog timekeeping hands. These representations may be shown on computer screens, video and camera screens, phone and personal-digital-assistant screens, and similar graphic displays. This embodiment may appear as an animated screen icon.

Mechanical and electronic means of moving timekeeping hands and driving digital or graphic displays are well known within the art, and not within the scope of the present invention. Setting and control of the timekeeping functions are dependent on the means selected and are well within the current art, including buttons and knobs.

It will be apparent to those skilled in this art that certain changes, modifications, and substitutions can be made without departing from the true spirit and scope of the appended claims.

1. A timekeeping device comprising;
at least one analog indicator,
changeable display areas at hour demarcation points,
and control means.

2. The device of claim 1 wherein a day of the week is represented by at least one alpha-numeric character within a display area.

3. The device of claim 1 wherein a day of the month is represented by at least one alpha-numeric character within a display area.

4. The device of claim 3 wherein the at least one alpha-numeric character is a numeral between 1 and 31 inclusive.

5. The device of claim 4, wherein a suffix corresponding to the displayed numeral provides added readability of the numeral for the user.

6. The device of claim 1 wherein a month of the year is represented by at least one alpha-numeric character within the display area.

7. The device of claim 6 wherein the at least one alpha-numeric character is a numeral between 1 and 12 inclusive.

8. The device of claim 1 wherein a calendar year is represented by a least one alpha-numeric character within the display area.

9. The device of claim 8 wherein the at least one alpha-numeric character is a numeral between 00 and 99 inclusive.

10. The timepiece of claim 1 wherein numerals between 1 and 12, inclusive, are displayed in traditional positions for hours 1 through 12 within the display areas.

11. The device of claim 1 wherein the hour of the day is represented by at least one alpha-numeric character within the display area.

12. The device of claim 11 wherein numerals between 1 and 12, inclusive, are displayed in traditional positions for hours 1 through 12 within the display area during the anti meridian period of the day.

13. The device of claim 11 wherein numerals between 13 and 24, inclusive, are displayed in traditional positions for hours 1 through 12 within the display area during the post meridian period of the day.

14. The device of claim 1 wherein symbols displayed in the display area are selected from the group consisting of roman numerals and icons and graphic representations.

15. The device of claim 1 wherein hour indicators are selectively made visible within the display area while other indicators are made blank thereby providing appealing graphical patterns.

16. The device of of claim 1 wherein hour indications within the display area periodically change appearance thereby conveying a continuous passage of time.

17. The device of claim 1 wherein previously stored information is shown at the display area selected from the group consisting of names and phone numbers and personal data.

18. The device of claim 1 wherein digital chronometer functions are shown at the display areas thereby conveying information selected from the group consisting of stopwatch values and elapsed time values and alarm clock settings and alternate time zones.

19. The device of claim 1 wherein a progressively moving transition is shown on the display area thereby graphically conveying trends selected from the group consisting of tide levels and moon phases and climate conditions and biometric data and measurements.

20. A timekeeping device comprising;
at least one analog indicator,
a changeable display area,
and hour indicators positioned in rotated locations by means of the changeable display area to represent an alternate time zone.
